(19) United States
(12) Patent Application Publication
(10) Pub. No.: US 2005/0263934 A1
(43) Pub. Date: Dec. 1, 2005

(54) Single side feed parked powder wave heating with wave flattener

(75) Inventors: Tae Mark Chung, Castaic, CA (US); Daniel Alfonso Delgado, Austin, TX (US)

Correspondence Address: 3D Systems, Inc., 26081 Avenue Hall, Valencia, CA, 91355, US

(73) Assignee: 3D Systems, Inc., Valencia, CA (US)

(21) Appl. No.: 10/856,303

(22) Filed: May 28, 2004

(51) Int. Cl. B29C 35/08

(52) U.S. Cl. 264/113; 264/497; 425/375; 425/174.8 R

(57) ABSTRACT

A method and apparatus for forming three dimensional objects by laser sintering that includes depositing the required quantities of powder for two successive layers on one side of the process chamber and simultaneously spreading the first layer while transporting the second layer quantity to the opposite side of the process chamber. The invention includes steps of parking the quantities of powder in sight of the part bed heater to pre-heat the powder and flattening the powder wave before the pre-heating step to improve pre-heat efficiency. This method and apparatus can result in reduction of the mechanisms, size, cost, and increase productivity of a laser-sintering device.

### BACKGROUND OF THE INVENTION

This invention is in the field of freeform fabrication, and is more specifically directed to the fabrication of three-dimensional objects by selective laser sintering.

The field of freeform fabrication of parts has, in recent years, made significant improvements in providing high strength, high density parts for use in the design and pilot production of many useful articles. Freeform fabrication generally refers to the manufacture of articles directly from computer-aided-design (CAD) databases in an automated fashion, rather than by conventional machining of prototype articles according to engineering drawings. As a result, the time required to produce prototype parts from engineering designs has been reduced from several weeks to a matter of a few hours.

By way of background, an example of a freeform fabrication technology is the selective laser sintering process practiced in systems available from 3D Systems, Inc., in which articles are produced from a laser-fusible powder in layerwise fashion. According to this process, a thin layer of powder is dispensed and then fused, melted, or sintered, by laser energy that is directed to those portions of the powder corresponding to a cross-section of the article. Conventional selective laser sintering systems, such as the Vanguard system available from 3D Systems, Inc., position the laser beam by way of an optics mirror system using galvanometer-driven mirrors that deflect the laser beam. The deflection of the laser beam is controlled, in combination with modulation of the laser itself, to direct laser energy to those locations of the fusible powder layer corresponding to the cross-section of the article to be formed in that layer. The computer based control system is programmed with information indicative of the desired boundaries of a plurality of cross sections of the part to be produced. The laser may be scanned across the powder in raster fashion, with modulation of the laser affected in combination with the raster scanning, or the laser may be directed in vector fashion. In some applications, cross-sections of articles are formed in a powder layer by fusing powder along the outline of the cross-section in vector fashion either before or after a raster scan that “fills” the area within the vector-drawn outline. In any case, after the selective fusing of powder in a given layer, an additional layer of powder is then dispensed, and the process repeated, with fused portions of later layers fusing to fused portions of previous layers (as appropriate for the article), until the article is complete.

Detailed description of the selective laser sintering technology may be found in U.S. Pat. No. 4,863,538, U.S. Pat. No. 5,132,143, and U.S. Pat. No. 4,944,817, all assigned to Board of Regents, The University of Texas System, and in U.S. Pat. No. 4,247,508, Housholder, all hereby incorporated by reference.

The selective laser sintering technology has enabled the direct manufacture of three-dimensional articles of high resolution and dimensional accuracy from a variety of materials including polystyrene, some nylons, other plastics, and composite materials such as polymer coated metals and ceramics. Polystyrene parts may be used in the generation of tooling by way of the well-known “lost wax” process. In addition, selective laser sintering may be used for the direct fabrication of molds from a CAD database representation of the object to be molded in the fabricated molds; in this case, computer operations will “invert” the CAD database representation of the object to be formed, to directly form the negative molds from the powder.

FIG. 1 illustrates, by way of background, a rendering of a conventional selective laser sintering system, shown generally as the numeral 100 currently sold by 3D Systems, Inc. of Valencia, Calif. FIG. 1 is a rendering shown without doors for clarity. A carbon dioxide laser 108 and its associated scanning system 114 are shown mounted in a unit above a process chamber 102 that includes a top layer of powder bed 132, two powder feed systems 124,126, and a spreading roller 130. The process chamber maintains the appropriate temperature and atmospheric composition (typically an inert atmosphere such as nitrogen) for the fabrication of the article.

Operation of this conventional selective laser sintering system 100 is shown in FIG. 2 in a front view of the process with no doors shown for clarity. A laser beam 104 is generated by laser 108, and aimed at target area 110 by way of optics-mirror scanning system 114, generally including galvanometer-driven mirrors that deflect the laser beam. The laser and galvanometer systems are isolated from the hot process chamber 102 by a laser window 116. The laser window 116 is situated interiorly of radiant heater elements 120 that heat the target area 110 and the powder bed 132 below. These heater elements 120 may be ring shaped (rectangular or circular) panels or radiant heater rods that surround the laser window. The deflection of the laser beam is controlled in combination with modulation of laser 108 itself, to direct laser energy to those locations of the fusible powder layer corresponding to the cross-section of the article to be formed in that layer. Scanning system 114 may scan the laser beam across the powder in a raster-scan fashion, or in vector fashion. Scanning entails the laser beam 104 intersecting the powder surface in the target area 110.

Two feed systems (124,126) feed powder into the system by means of a push-up piston system. Target area 110 receives powder from the two feed systems as described hereinafter. Feed system 126 first pushes up a measured amount of powder and a counter-rotating roller 130 picks up and spreads the powder over the powder bed 132 in a uniform manner. The counter-rotating roller 130 passes completely over the target area 110 and powder bed 132 and then dumps any residual powder into an overflow receptacle 136. Positioned nearer the top of the chamber are radiant heater elements 122 that pre-heat the feed powder and a ring or rectangular shaped radiant heater element 120 for heating the surface of the powder bed 132. Element 120 has a central opening which allows a laser beam to pass through the laser window or optical element 116. After a traversal of the counter-rotating roller 130 across the powder bed 132, the laser 108 selectively fuses the layer just dispensed. The roller 130 then returns from the area of the overflow receptacle 136, the feed piston 125 pushes up a prescribed amount of powder, the roller 130 dispenses powder over the target area 110 in the opposite direction and roller 130 proceeds to the other overflow receptacle 138 to drop any residual powder. Before the roller begins each traverse of the system the center part bed piston 128 drops by the desired layer thickness to make room for additional powder.

The powder delivery system in system 100 includes feed pistons 125 and 127, controlled by motors (not shown) to move upwardly and lift, when indexed, a volume of powder into chamber 102. Part bed piston 128 is controlled by a motor (not shown) to move downwardly below the floor of chamber 102 by a small amount, for example 0.125 mm, to define the thickness of each layer of powder to be processed. Roller 130 is a counter-rotating roller that translates powder from feed pistons 125 and 127 onto target area 110. When traveling in either direction the roller 130 carries any residual powder not deposited on the target area into overflow receptacles (136,138) on either end of the process chamber 102. Target area 110, for purposes of the description herein, refers to the top surface of heat-fusible powder (including portions previously sintered, if present) disposed above part piston 128. The sintered and unsintered powder dispensed on part bed piston 128 is referred to as part cake 106. System 100 of FIG. 2 also requires radiant heaters 122 over the feed pistons to pre-heat the powders to minimize any thermal shock as fresh powder is spread over the recently sintered and hot target area 110. This type of dual push-up piston feed system, providing fresh powder from below the target area, with heating elements for both feed beds and the part bed or target area is implemented commercially in the Vanguard selective laser sintering system sold by 3D Systems, Inc. of Valencia, Calif.

Another known powder delivery system uses overhead hoppers to feed powder from above and either side of target area 110, in front of a delivery apparatus such as a wiper or scraper.

There are advantages and disadvantages to each of these systems. Both require a number of mechanisms, either push-up pistons or overhead hopper systems with metering feeders to effectively deliver metered amounts of powder to each side of the target area and in front of the spreading mechanism (either a roller or a wiper blade).

Although a design such as system 100 has proven to be very effective in delivering both powder and thermal energy in a precise and efficient way there is a need to do so in a more cost effective manner by reducing the number of mechanisms and improving the pre-heating of fresh powder to carry out the selective laser sintering process. A method and apparatus for pre-heating fresh powder for doing that is presented in concurrently filed co-pending application U.S. Ser. No. To Be Assigned, docket number USA.304, filed May 28, 2004 and assigned to 3D Systems, Inc. of Valencia, Calif. That application is hereby incorporated by reference.

Briefly, this concurrently filed co-pending application provides for a method and apparatus with a depositing step for fresh powder wherein the depositing step includes at least depositing all of the powder required for two successive layers on the first side of target area in the process chamber which simultaneously spreads the powder for the first successive layer while transporting the powder for the second successive layer to the opposing second side of the target area. The apparatus includes a powder feed hopper, located above and on the first side of the target area, for feeding desired amounts of the powder, a means for spreading a first layer of powder over the target area while carrying a second quantity of powder to the second side of the target area to be used for a second layer of powder, and a means for depositing the second quantity of powder on the opposing second side of target area.

FIGS. 3 & 4 show a parked powder wave 184 initially being deposited from an overhead feed mechanism and subsequently positioned next to target area 186 during the laser scanning of the target area. The parked powder wave 184 is so placed to expose the powder wave to the radiant energy of heaters 160. This allows the radiant heaters 160, which are maintaining the proper temperature of the target area 186, to also pre-heat the powder wave 184 that will be used in the next layer to reduce or eliminate the need to separately pre-heat the next layer of powder. This technique, while effective, suffers because of the poor thermal conductivity of polymer powders and its effect on the mound of powder in the parked wave that consequently heats more slowly than desired, resulting in a longer than desired delay before spreading the next layer. Additionally, there is the potential in this approach when feeding small particle size powders that a dust cloud can be generated when powder from feed mechanism 164 falls directly from the feed mechanism to the floor of the process chamber in forming parked powder wave 184.

There is thus a need to speed up the process of heating the parked wave of powder without increasing the temperature of the radiant heaters 160, which would adversely affect the temperature of the target area 180. There is also a need to significantly reduce the potential of dusting of the powders falling from the feed mechanism 164 onto the floor of the process chamber.

### BRIEF SUMMARY OF THE INVENTION

It is therefore an aspect of the present invention to provide a method and apparatus to rapidly heat the parked fresh powder wave.

It is also an aspect of the instant invention to reduce the potential of dust being created by the falling of powder from an overhead feeder onto the floor of the process chamber.

It is a feature of the present invention that the cover or cowling overlying the roller mechanism extends sufficiently far toward the powder bed surface to smooth or flatten the wave or mound of the fresh powder deposited adjacent the target area.

It is another feature of the present invention that the cover or cowling overlying the roller mechanism is angled on opposing sides to permit the fresh powder to slide along it to the powder bed.

It is an advantage of the present invention that the fresh powder wave is deposited on the powder bed surface and flattened out by the cover or cowling overlying the roller mechanism.

The invention includes a method for forming a three dimensional article by laser sintering that includes at least the steps of: depositing a quantity of powder on a first side of a target area; flattening the first quantity of powder on the first side of the target area; spreading the powder with a spreading mechanism to form a first smooth surface; directing an energy beam over the target area causing the powder to form an integral layer; depositing a second quantity of powder on a second side of the target area; flattening the second quantity of powder on the second side of the target area; spreading the powder with the spreading mechanism to form a second smooth surface; directing the energy beam over the target area causing powder to form a second integral layer bonded to the first integral layer; and repeating the steps to form additional layers that are integrally bonded to adjacent layers so as to form a three dimensional article, wherein the depositing step includes at least depositing all of the powder required for two successive layers on the first side of the target area and simultaneously spreading the powder for the first successive layer while transporting the powder for the second successive layer to the second side of the target area.

The invention also includes an apparatus for producing parts from a powder comprising a chamber having a target area at which an additive process is performed, the target area having a first side and a second side; a means for fusing selected portions of a layer of the powder at the target area; a powder feed hopper, located above and on the first side of the target area for feeding desired amounts of the powder; a means for flattening a first quantity of powder on the first side of the target area; a means for spreading a first layer of powder over the target area while carrying a second quantity of powder to the second side of the target area to be used for a second layer of powder; a means for depositing the second quantity of powder on the second side of target area, a means for flattening the second quantity of powder on the second side of the target area; and a means for spreading the second quantity of powder over the target area.

### BRIEF DESCRIPTION OF DRAWINGS

These and other aspects, features and advantages of the invention will become apparent upon consideration of the following detailed disclosure, especially when taken in conjunction with the accompanying drawings wherein:

FIG. 1 is a diagrammatic view of a conventional prior art selective laser-sintering machine;

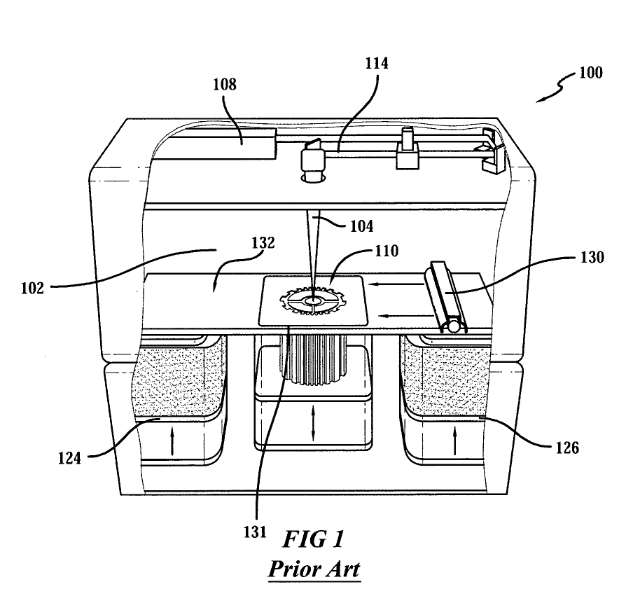

FIG. 2 is a diagrammatic front elevation view of a conventional prior art selective laser-sintering machine showing some of the mechanisms involved;

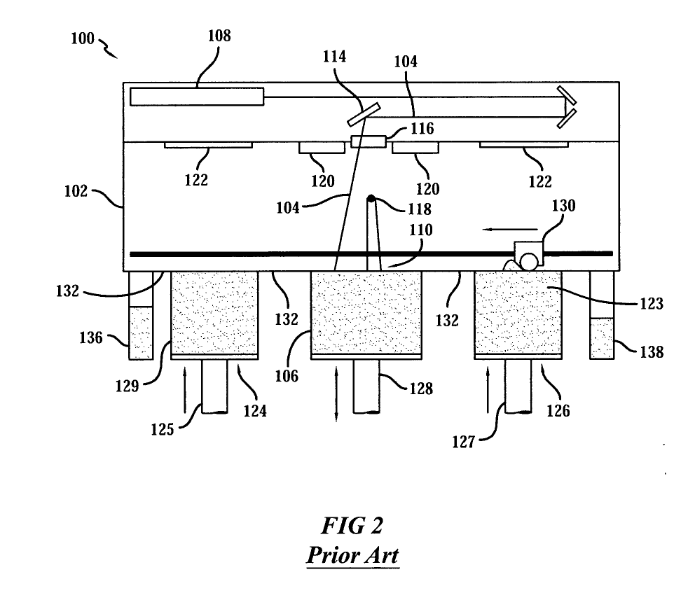

FIG. 3 is a diagrammatic front elevation view of the system of the co-pending application showing the metering of the powder in front of the roller;

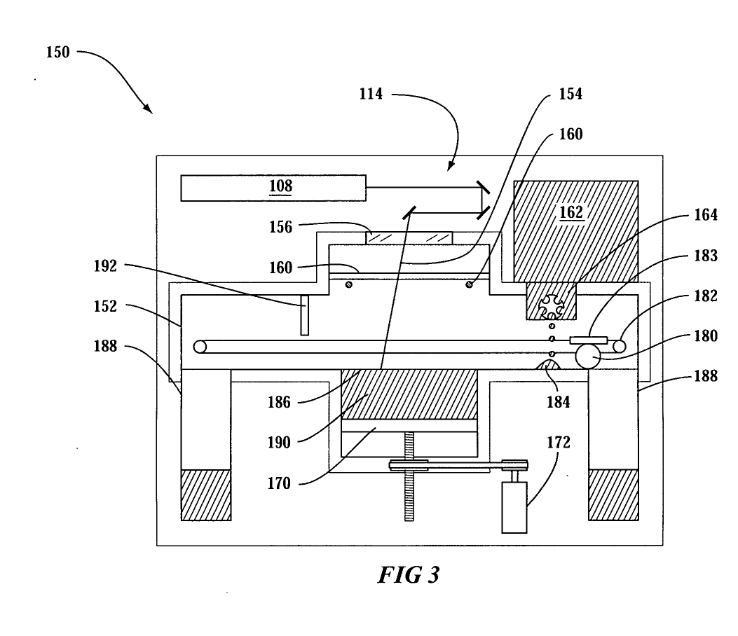

FIG. 4 is a diagrammatic front elevation view of the system of the co-pending application showing the retraction of the roller mechanism and the parking of it under the feed mechanism while the laser is selectively heating the target area and the radiant heater is pre-heating the parked powder wave;

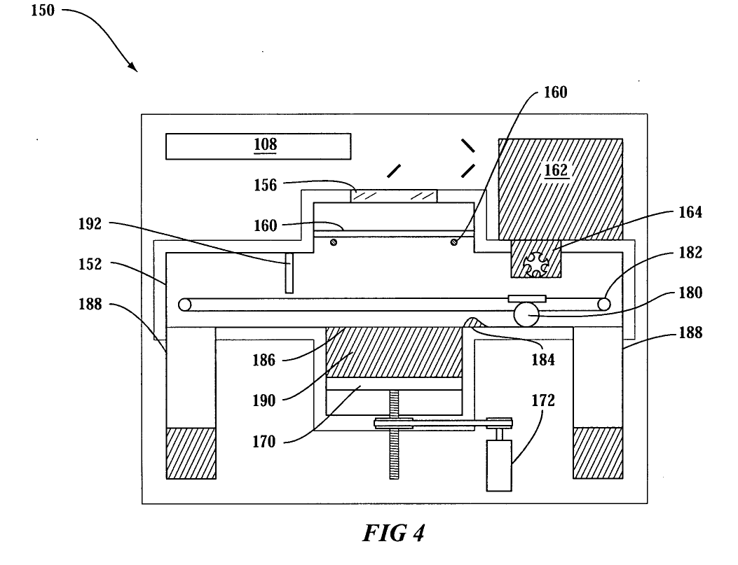

FIG. 5 is a partial diagrammatic front elevation view of the system of the present invention showing a design aspect of modified cover of the roller mechanism;

FIG. 6 is a partial diagrammatic front elevation view of the system of the present invention showing the depositing of powder using the cover of the roller mechanism;

FIG. 7 is a partial diagrammatic front elevation view of the system of the present invention showing the parking of the first powder quantity near the part bed;

FIG. 8 is a partial diagrammatic front elevation view of the system of the present invention showing the method of flattening of the parked powder wave;

FIG. 9 is a diagrammatic front elevation view of the system of the present invention showing the metering of the first quantity of powder;

FIG. 10 is a diagrammatic front elevation view of the system of the present invention showing the parking of the powder wave near the part bed;

FIG. 11 is a diagrammatic front elevation view of the system of the present invention showing the retraction of the spreading mechanism, the flattening of the parked powder wave, and the parking of the spreading mechanism under the feed mechanism while the laser is selectively heating the target area and the radiant heater is pre-heating the flattened parked powder wave;

FIG. 12 is a diagrammatic front elevation view of the system of the present invention showing the dispensing of the second layer of powder onto the top of the roller mechanism and the radiant heater is pre-heating the flattened parked powder wave;

FIG. 13 is a diagrammatic front elevation view of the system of the present invention showing the first layer of powder being distributed across the target area and the second layer of powder being carried on top of the roller mechanism to the opposing second side of the target area;

FIG. 14 is a diagrammatic front elevation view of the system of the present invention showing the depositing of the second layer of powder in front of the roller and depositing of residual powder from the first layer in the overflow receptacle;

FIG. 15 is a diagrammatic front elevation view of the system of the present invention showing the parking of the second powder wave near the target area;.

FIG. 16 is a diagrammatic front elevation view of the system of the present invention showing the parking of the roller to the side and the flattening of the second parked powder wave while the laser is selectively heating the target area and the radiant heater is pre-heating the flattened parked powder wave;

FIG. 17 is a diagrammatic front elevation view of the system of the present invention showing the second layer of powder being distributed across the target area;

FIG. 18 is a diagrammatic front elevation view of the system of the present invention showing the roller completing one cycle by depositing residual powder in the overflow receptacle; and

FIG. 19 is a diagrammatic front elevational view of an alternative embodiment of the system of the present invention showing a second stationary blade for dislodging and depositing of the first layer of powder in front of the roller on the opposing side of the target area from the first stationary blade.

### DETAILED DESCRIPTION OF THE INVENTION

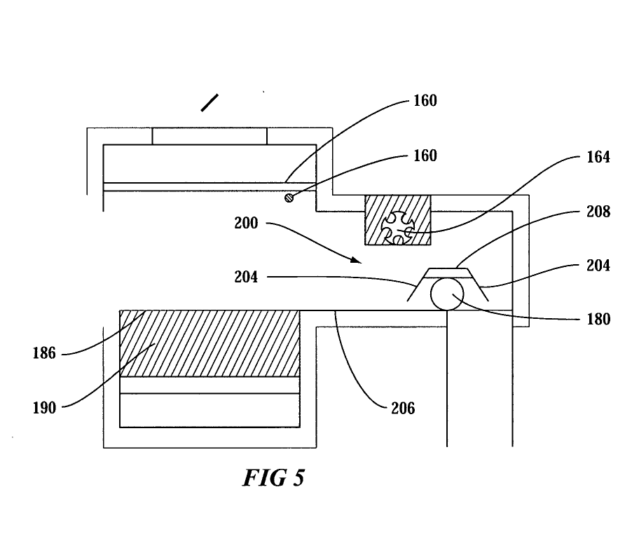

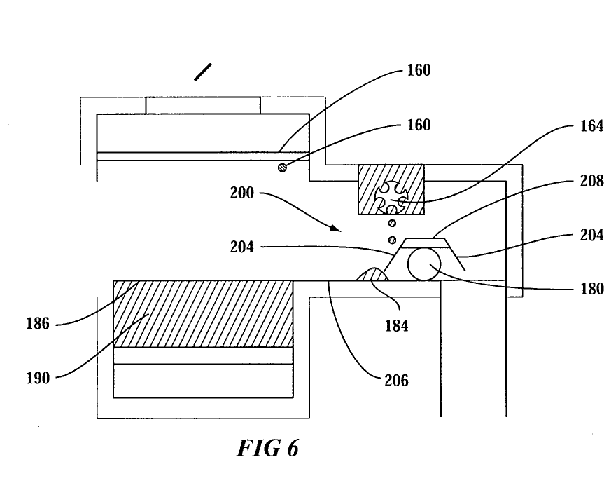

The concept of the present invention includes a redesign of the overlaying structure or cowling covering the roller mechanism. Referring to FIG. 5 the new roller assembly is shown overall by the numeral 200. Over roller mechanism 180 is a flat top powder support or carrying surface 208 that is used by the process to carry the powder quantity needed for the second side of the chamber. A cover 204 is added to the structure that is angled outwardly on each side to provide adequate clearance for the powder wave created by the roller. The cover 204 extends downwardly at an angle on opposing sides leaving a small clearance between the roller in roller mechanism 180 and the floor 206 of the process chamber 152. In operation, as seen in FIG. 6, the process begins with the roller mechanism 180 parked below and slightly to the side of the overhead feed mechanism 164. The first quantity of powder is discharged to fall on the exterior of cover 204 and slides down forming a powder wave 184 on the floor 206 adjacent to roller mechanism 180. By dropping the powder onto the exterior cover of roller assembly 200 in this manner the creation of a dust cloud is substantially reduced. The powder falls a shorter distance before its vertical fall is interrupted than previously by striking cover 204 at an angle, thereby reducing its terminal velocity, and sliding gently down onto the floor 206 of the process chamber 152. The deposited quantity of powder will be referred to as a parked powder wave.

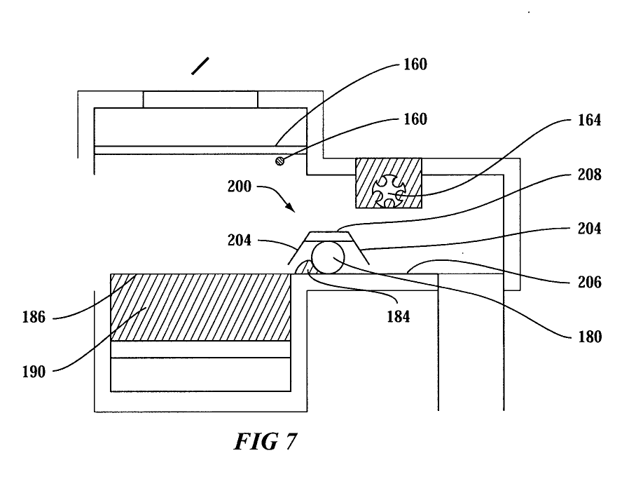

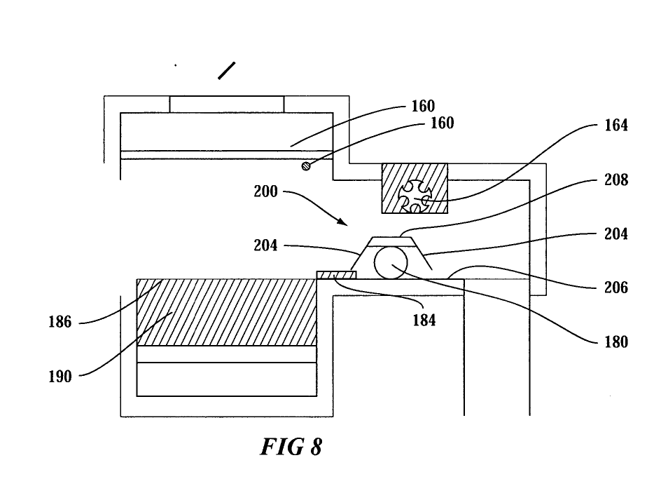

In the next step, as seen in FIG. 7, roller mechanism 180 is activated and moves to push powder wave 184 and park it on the edge of target area 186. The powder wave 184 is flattened by the leading edge of roller cover 204 as it passes over the powder wave but is built up again by the action of the roller mechanism 180. When roller mechanism 180 reverses direction though (see FIG. 8) and returns to its position under the feed mechanism 164 the inside edge of the roller cover 204 cleanly flattens the powder wave 184 into a thinner wave that allows much more rapid heating of parked powder wave 184 by radiant heaters 160. This design and process reduces heating time of powder wave 184 before the ensuing process steps that include advancing roller mechanism 180 across target area 186 to spread the next layer of pre-heated powder across the target area.

The same sequence of steps on the opposing second side of the process chamber 102 will flatten the parked powder wave on that side of the chamber once the second powder wave is dislodged from the top powder support or carrying surface 208, as will be explained hereafter. Although the roller mechanism 180 described is a preferred one, it should be evident that a number of variations of shapes of the roller assembly 200 could accomplish the twin goals of providing a gentle landing of the disbursed powder and flattening of the powder wave prior to pre-heating the wave.

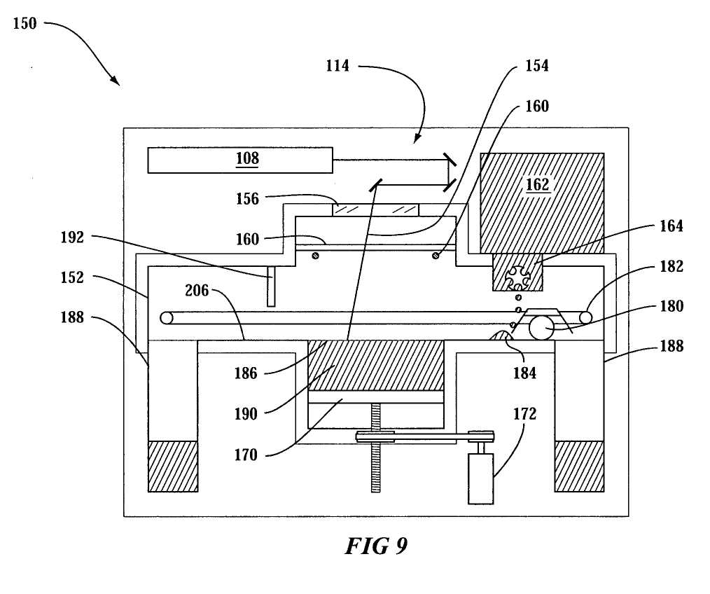

A laser sintering system employing the present invention is shown in FIG. 9 indicated generally by the numeral 150. The process chamber is shown as 152. The laser beam 154 passing from laser 108 through the optics mirror scanning system 114 enters the chamber 152 through a laser window 156 that isolates the laser and optics (not shown) from the higher temperature environment of the process chamber 152. The optics mirror scanning system 114 is similar to the one described in the prior art, but any suitable design may be employed. Radiant heating elements 160 provide heat to the target area 186 and to the powder in areas immediately next to the target area 186. These radiant heaters can be any number of types including, for example, quartz rods or flat panels or combinations thereof. A preferred design employs fast response quartz rod heaters.

A single overhead powder feed hopper 162 is shown with a bottom feed mechanism 164 controlled by a motor (not shown) to control the amount of powder dropped onto the process chamber floor 206 below. The feed mechanism 164 can be of several types including, for example, a star feeder, an auger feeder, a belt feeder, a slot feeder or a rotary drum feeder. A preferred feeder is a rotary drum. A part piston 170 is controlled by a motor 172 to move downwardly below the floor 206 of the chamber 152 by a small amount, for example 0.125 mm, to define the thickness of each layer of powder to be processed.

Still referring to FIG. 9, roller mechanism 180 includes a counter-rotating roller, driven by motor 182, that spreads powder from powder wave 184 across the laser target area 186. When traveling in either direction the roller carries any residual powder not deposited on the target area into overflow receptacles 188 on opposing ends of the chamber 152. Target area 186, for purposes of the description herein, refers to the top surface of heat-fusible powder (including portions previously sintered, if present) disposed above part piston 170. The sintered and unsintered powder disposed on part piston 170 will be referred to herein as part cake 190. Although the use of counter-rotating roller mechanism 180 is preferred, the powder can also be spread by other means such as a wiper or a doctor blade.

Operation of the selective laser sintering system of this invention is shown beginning in FIG. 9. In a first powder dispensing step powder is metered from above from feed mechanism 164 onto cover structure 204 and then slides to a position on the floor 206 in front of roller mechanism 180. The quantity of powder metered will depend upon the size of target area 186 and the desired layer thickness to be formed.

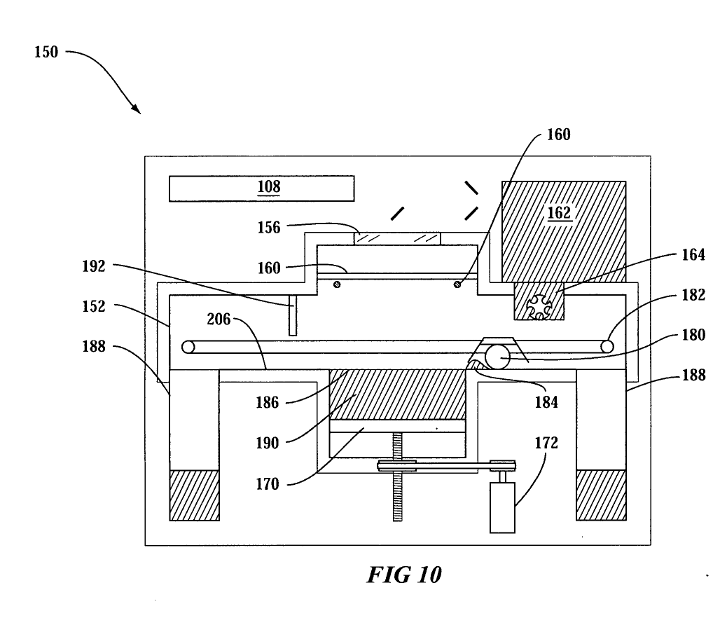

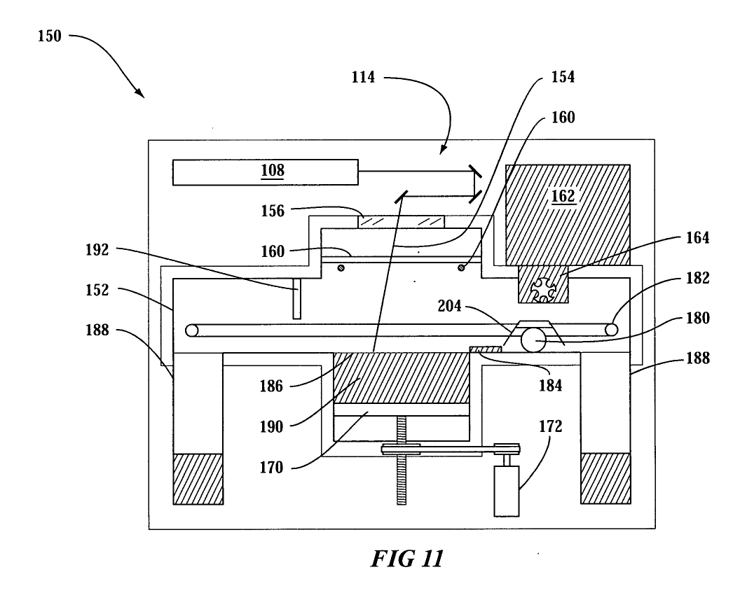

In a second step, shown in FIG. 10, the counter-rotating roller mechanism is activated to move the powder wave slightly forward and park it at the edge of target area 186 in view of radiant heater elements 160. In a third step, shown in FIG. 11, roller mechanism 180 is moved back and roller cover structure 204 flattens parked powder wave 184. Roller mechanism 180 is then parked under feed mechanism 164. In iterations other than the first quantity of powder metered from feed mechanism 164, the laser is then turned on and laser beam 154 scans the current layer to selectively fuse the powder on that layer. While the laser is scanning, roller mechanism 180 remains parked directly under the powder feeder mechanism. Also while the laser is scanning, flattened parked powder wave 184 is pre-heated by the action of radiant heater elements 160. This step can eliminate the need for separate radiant heaters to pre-heat the powder.

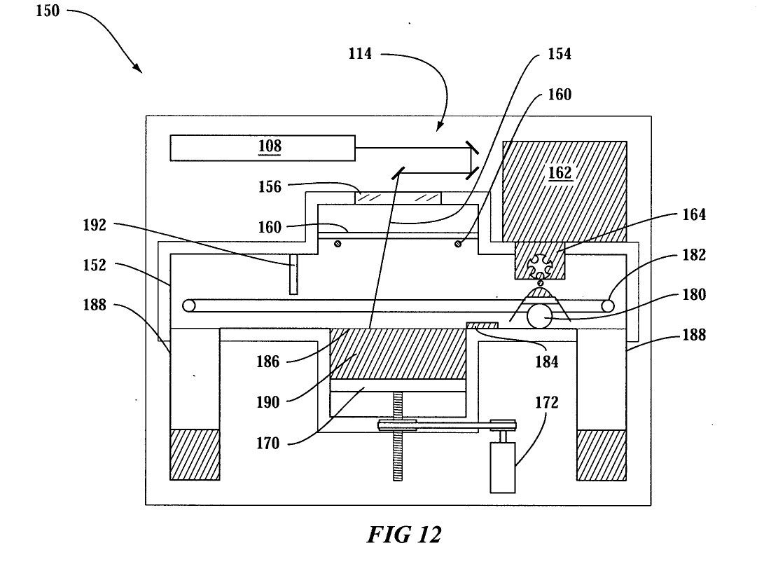

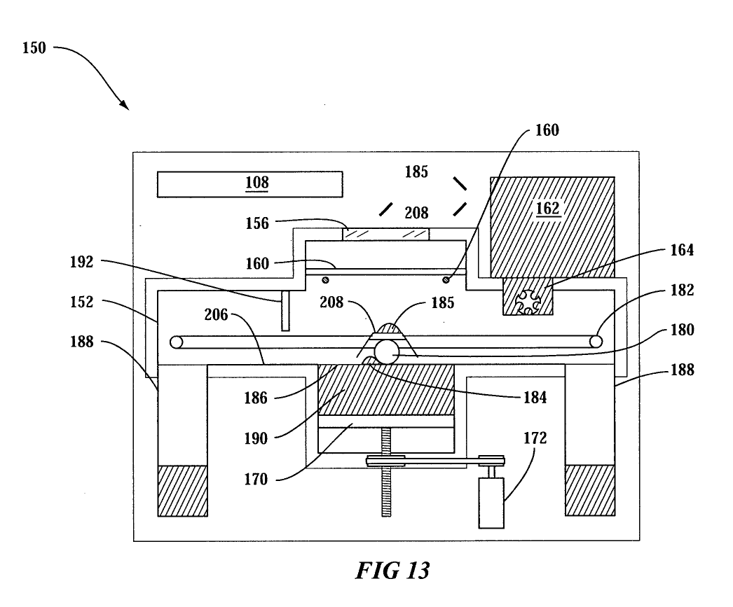

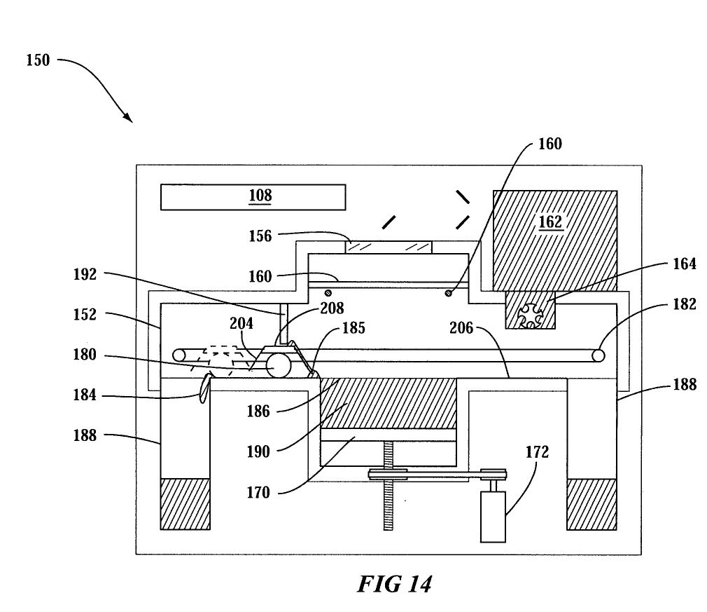

In a next step, shown in FIG. 12, a second powder wave 185 is fed onto top powder support or carrying surface 208 of roller mechanism 180. After scanning of the current layer of powder the next step, shown in FIG. 13, begins. Roller mechanism 180 is activated and traverses across the process chamber 152, spreading the first layer of pre-heated powder 184 across the target area 186, while carrying the second layer of powder in second powder wave 185 on top powder support surface 208 of roller mechanism 180. In the next step, shown in FIG. 14, a mounted stationary blade 192 dislodges the second powder wave 185 off the top powder support surface 208 of roller mechanism 180 as the roller passes under the blade 192. The dislodged powder slides down the inboard side of angled cover 204, depositing the second powder wave 185 on the floor 206 of process chamber 152 while the roller mechanism 180 proceeds to feed any excess powder into overflow receptacle 188. The apparatus is not limited to a stationary blade for dislodgement, but could encompass any mechanism that would dislodge the powder from the top powder supporting or carrying surface 208 of roller mechanism 180 such as a skive, roller or brush.

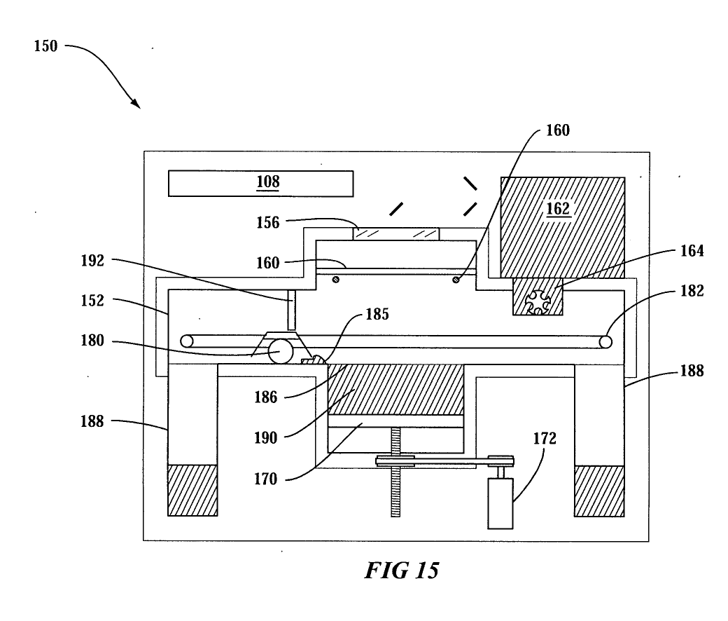

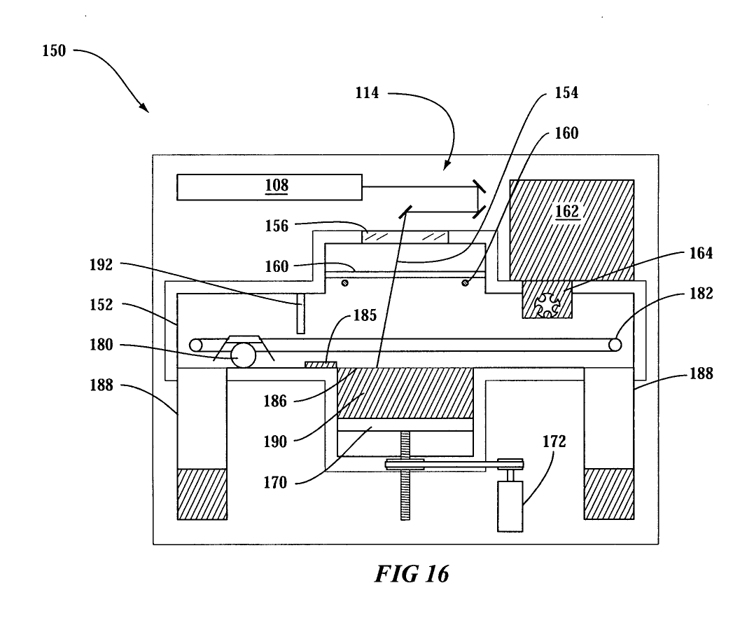

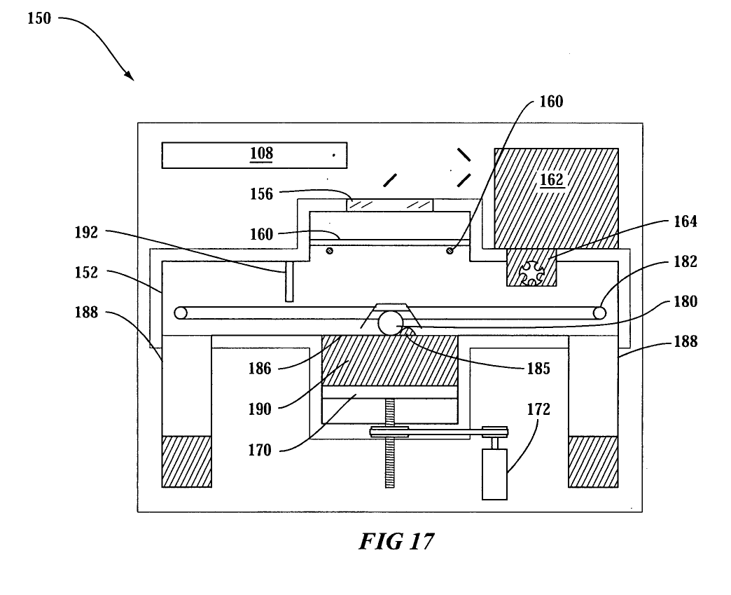

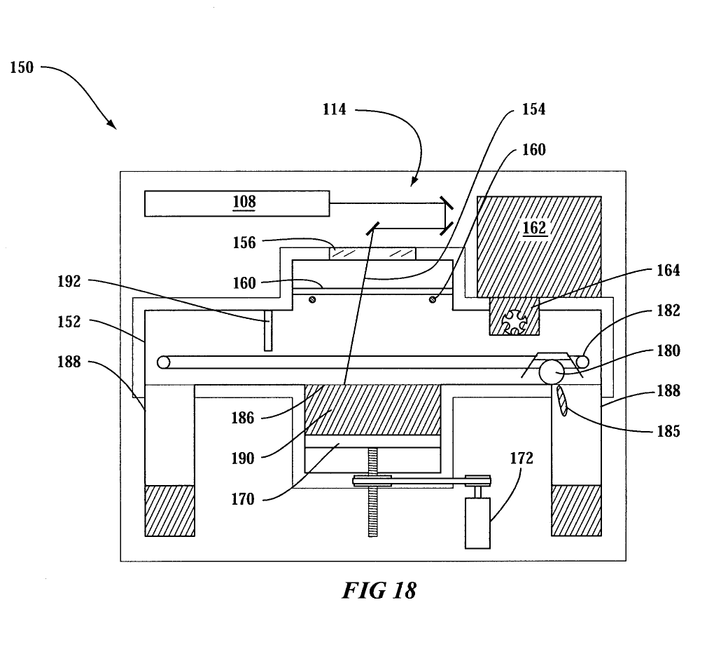

In the next step, shown in FIG. 15, roller mechanism 180 immediately reverses and moves to park the second powder wave 185 near the target area 186 and in sight of the radiant heater elements 160 sufficiently close to receive heating effects from them. In the next step (FIG. 16) of this preferred embodiment, roller mechanism 180 moves back and flattens parked powder wave 185, with the inboard side of angled cover 204 contacting and leveling the mound of second powder wave 185. Roller mechanism 180 then parks while the laser scanning action is completed and the flattened second quantity of powder in second powder wave 185 is being pre-heated by the radiant heating elements 160. After the laser scanning action is completed, roller mechanism 180 is then activated and moves to spread the second quantity of powder in second powder wave 185 over target area 186 as shown in FIG. 17. After spreading the powder roller mechanism 180, as seen in FIG. 18, proceeds to the end of its run and drops any excess powder into overflow receptacle 188. This completes the cycle and the next cycle is ready to proceed as in FIG. 9.

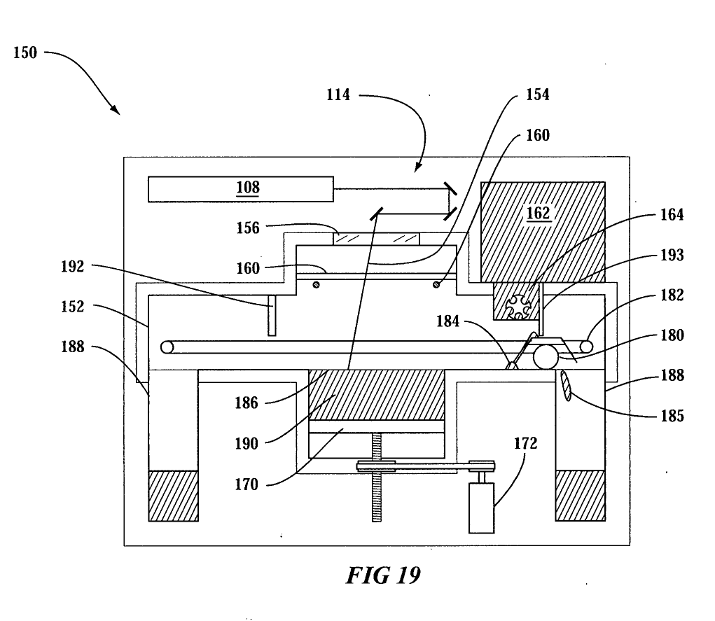

An alternative design can include a second mounted stationary blade 193 shown in FIG. 19 outboard of the bottom feed mechanism 164 on the opposing side from blade 192 so that a quantity of powder to be deposited on the powder support surface 208 is always present and being preheated for each traversal of the roller mechanism 180 across the target area 186. In this approach, the iterative cycle has the first parked powder wave 184 be deposited on the top powder support surface 208 of the roller mechanism 180. The roller mechanism 180 is moved a short distance toward blade 193 so that the blade dislodges the quantity of powder that forms parked powder wave 184. The roller mechanism 180 moves forward and then reverses direction a short distance so what is now the inboard side of angled cover 204 of roller mechanism 180 flattens parked powder wave 184 to promote faster preheating. Roller mechanism 180 reverses its direction to pull away from the leveled mound of powder and remains stationary while pre-heating occurs for the first quantity of powder metered in the first iteration and in subsequent iterations while laser scanning occurs. For the first iteration roller mechanism 180 is repositioned under the bottom of feed mechanism 164 and the powder carrying surface 208 is refilled with the second powder wave 185.

This inventive design achieves rapid and efficient pre-heating of distributed powder before it is spread across the target area of a selective laser sintering system and reduces the potential of dust clouds forming from dropped powder striking the floor of the process chamber.

While the invention has been described above with references to specific embodiments, it is apparent that many changes, modifications and variations in the materials, arrangement of parts and steps can be made without departing from the inventive concept disclosed herein. Accordingly, the spirit and broad scope of the appended claims is intended to embrace all such changes, modifications and variations that may occur to one of skill in the art upon a reading of the disclosure. For example, the pre-heating of the parked powder waves may employ the use of the laser beam, either on low power or with a fast scan speed to assist in elevating the powder temperature but not initiate melting or softening of the powder to the extent that even spreading across the powder bed is hampered. Additionally, additional radiant heating panels, such as Watlow flat panel heaters, can be positioned above the parked powder locations on opposing sides of the process chamber suitably mounted, such as in the roller mechanism's traversing assembly or other suitable arrangement. All patent applications, patents and other publications cited herein are incorporated by reference in their entirety.

1. A method for forming a three dimensional article by laser sintering comprising the steps of:
(a) depositing, in a first depositing step, a first quantity of powder on a first side of a target area;
(b) flattening, in a first flattening step, the first quantity of powder on the first side of target area;
(c) spreading, in a first spreading step, the first quantity of powder with a spreading mechanism to form a first layer of powder;
(d) directing an energy beam over the target area causing the first layer of powder to form an integral layer;
(e) depositing, in a second depositing step, a second quantity of powder on an opposing second side of the target area;
(f) flattening, in a second flattening step, the second quantity of powder on the second side of the target area.
(g) spreading, in a second spreading step, the second quantity of powder with the spreading mechanism to form a second layer of powder;
(h) directing the energy beam over the target area causing the second layer of powder to form a second integral layer bonded to the first integral layer;
(i) repeating steps (a) to (f) to form additional layers that are integrally bonded to adjacent layers so as to form a three dimensional article, wherein the first depositing step comprises feeding the first quantity of powder in front of the spreading mechanism and feeding the second quantity of powder on the spreading mechanism wherein the second quantity of powder is carried during the first spreading step from the first side to the second side of the target area and the second depositing step comprises dislodging the second quantity of powder from the moving spreading mechanism to deposit the second quantity of powder on the second side of the target area.

2. The method of claim 1 further comprising using a roller as the spreading mechanism.

3. The method of claim 2 wherein the roller is a counter-rotating roller.

4. The method of claim 1 further comprising using a wiper blade as the spreading mechanism.

5. The method of claim 3 comprising using a laser beam in the directing step.

6. The method of claim 5 wherein the laser beam is a carbon dioxide laser.

7. The method of claim 1 further comprising depositing the quantity of powder from an overhead feed mechanism onto a powder carrying structure on the spreading mechanism.

8. The method of claim 1 wherein the dislodging of the second quantity of powder from the moving spreading mechanism is accomplished by a stationary blade.

9. The method of claim 1 wherein the flattening steps utilize a cover attached to the spreading mechanism that flattens the first and second quantities of powder after they are deposited.

10. The method of claim 1 further comprising depositing the first quantity of powder from an overhead feed mechanism onto a powder carrying structure on the spreading mechanism.

11. The method of claim 10 further comprising dislodging the first quantity of powder from the powder carrying structure on a side adjacent the target area.

12. The method of claim 1 further comprising the additional steps of:
(a) after the first flattening step, pre-heating by means of radiant heat the first quantity of powder; and
(b) after the second flattening step, pre-heating by means of radiant heat the second quantity of powder.

13. The method of claim 12 further comprising using laser energy to heat the first quantity and the second quantity of powder.

14. An apparatus for producing parts from a powder, comprising in combination:
(a) a chamber having a target area at which an additive process is performed, the target area having a first side and an opposing second side;
(b) means for fusing selected portions of a layer of the powder at the target area;
(c) a powder feed hopper, located above and on the first side of the target area for depositing a first and a second quantity of powder into the chamber;
(d) means for spreading the first quantity of powder as a first layer of powder over the target area while carrying a second quantity of powder to the opposing second side of the target area to be used for forming a second layer of powder;
(e) means for flattening the first quantity of powder before it is spread;
(f) means for depositing the second quantity of powder on the second side of target area;
(g) means for spreading the second quantity of powder over the target area; and
(h) means for flattening the second quantity of powder before it is spread.

15. The apparatus of claim 14, wherein the means for spreading comprises:
(a) a roller;
(b) a motor coupled to the roller for moving the roller across the target area to spread the first layer of powder; and
(c) a carrying surface associated with the roller to receive and carry the second quantity of powder for depositing on the second side of the target area.

16. The apparatus of claim 14, wherein the means for depositing the second amount of powder on the second side of the target area further comprises a device for dislodging the second quantity of powder from the carrying surface.

17. The apparatus of claim 16 wherein the device for dislodging the second amount of powder is a stationary blade.

18. The apparatus of claim 14 further comprising a second device for dislodging powder from the carrying surface positioned on the opposing side of the target area from the first device.

19. The apparatus of claim 18 wherein the second device for dislodging powder further comprises a second stationary blade.

20. The apparatus of claim 14 wherein the means for fusing selected portions of a layer of the powder at the target area comprises:
(a) a energy beam;
(b) an optics mirror system to direct the energy beam; and
(c) energy beam control means coupled to the optics mirror system including computer means, the computer means being programmed with information indicative of the desired boundaries of a plurality of cross sections of the part to be produced.

21. The apparatus of claim 20 wherein the energy beam is a laser energy beam.

22. The apparatus of claim 15 further comprising cover elements attached to and on opposing sides of the carrying surface for flattening each of the first and second quantities of powder.

23. The apparatus of claim 16 wherein the cover elements attached to the carrying surface extend downwardly and away from the carrying structure to a height above the target area equivalent to desired height of a flattened powder wave.

24. The apparatus of claim 14 further comprising means for heating powder in the chamber.

25. The apparatus of claim 24 wherein the means for heating powder are radiant heating elements.

26. The apparatus of claim 25 wherein the means for heating powder further comprises a laser energy beam.
